(19) United States
(12) Patent Application Publication
(10) Pub. No.: US 2023/0095969 A1
(43) Pub. Date: Mar. 30, 2023

(54) LIQUID HANDLING DEVICE AND LIQUID HANDLING SYSTEM

(71) Applicant: Enplas Corporation, Kawaguchi-shi (JP)

(72) Inventor: Nobuya Sunaga, Saitama (JP)

(21) Appl. No.: 17/942,195

(22) Filed: Sep. 12, 2022

(30) Foreign Application Priority Data
Sep. 30, 2021 (JP) 2021-161806

(51) Int. Cl. B01L 3/00

(52) U.S. Cl. CPC B01L 3/502746; B01L 3/52; B01L 2300/0816; B01L 2200/0689; B01L 2400/0638; B01L 2400/0487; B01L 2300/123; B01L 2400/086; B01L 2300/0809; B01L 2200/16

(57) ABSTRACT

A liquid handling device includes: a cartridge including a first reservoir part in which a first reagent that is preservable in a non-frozen state is stored; and a channel chip including a second reservoir part in which a second reagent that should be preserved in a frozen state is stored, and a channel connected to the second reservoir part. The cartridge is attachable and detachable to and from the channel chip. The first reservoir part is connected to the channel when the cartridge is mounted in the channel chip.

This application is entitled to the benefit of Japanese Patent Application No. 2021-161806, filed on Sep. 30, 2021, the disclosure of which including the specification, drawings and abstract is incorporated herein by reference in its entirety.

### TECHNICAL FIELD

The present invention relates to a liquid handling device and a liquid handling system.

### BACKGROUND ART

In recent years, channel chips and other devices have been used to analyze cells, proteins, nucleic acids, and other substances. The advantage of channel chips is that the amount of reagents and samples required for analysis is small, and they are expected to be used in various applications such as clinical testing, food testing, and environmental testing.

For example, PTL 1 discloses a micro channel system including a large capacity reagent supply device storing reagent and buffer reservoirs, a rehydration cover with a small volume storing PCR reagents and other reagents, and a chip including channels. In the micro channel system disclosed in PTL 1, the chip, the reagent supply device, and the rehydration cover are constructed separately. This micro channel system disclosed in PTL 1 is used in the state where the reagent supply device and the rehydration cover are externally connected to the chip.

### CITATION LIST

### Patent Literature

PTL 1

US Patent Application Publication No. 2014/0206073

### SUMMARY OF INVENTION

### Technical Problem

However, the micro channel system disclosed in PTL 1 has a problem that the dead volume is increased due to the external connection of a rehydration cover with a small capacity, resulting in a large loss of the small amount of reagent stored in the rehydration cover.

An object of the present invention is to provide a liquid handling device and a liquid handling system that can reduce the waste of small quantities of reagent.

### Solution to Problem

A liquid handling device according to an embodiment of the present invention includes: a cartridge including a first reservoir part in which a first reagent that is preservable in a non-frozen state is stored; and a channel chip including a second reservoir part in which a second reagent that should be preserved in a frozen state is stored, and a channel connected to the second reservoir part. The cartridge is attachable and detachable to and from the channel chip and the first reservoir part is connected to the channel when the cartridge is mounted in the channel chip.

A liquid handling system according to an embodiment of the present invention includes: the liquid handling device; and a liquid control device configured to control liquid flowing through the liquid handling device.

### Advantageous Effects of Invention

According to the present invention, it is possible to provide a liquid handling device and a liquid handling system that can reduce the waste of small quantities of reagent.

### BRIEF DESCRIPTION OF DRAWINGS

FIG. 1 is a perspective view of a liquid handling system according to an embodiment of the present invention;

FIG. 2 is a schematic sectional view of the liquid handling system;

FIG. 3 is a plan view of a channel chip;

FIGS. 4A to 4C are diagrams illustrating a configuration of a substrate and a film;

FIGS. 5A and 5B are schematic views illustrating a configuration of a first rotary member; and

FIGS. 6A and 6B are schematic views illustrating a configuration of a second rotary member.

### DESCRIPTION OF EMBODIMENTS

A liquid handling system according to an embodiment of the present invention is elaborated below with reference to the accompanying drawings. In the present embodiment, a liquid handling device and a liquid handling system for processing liquid are described.

### Configuration of Liquid Handling System

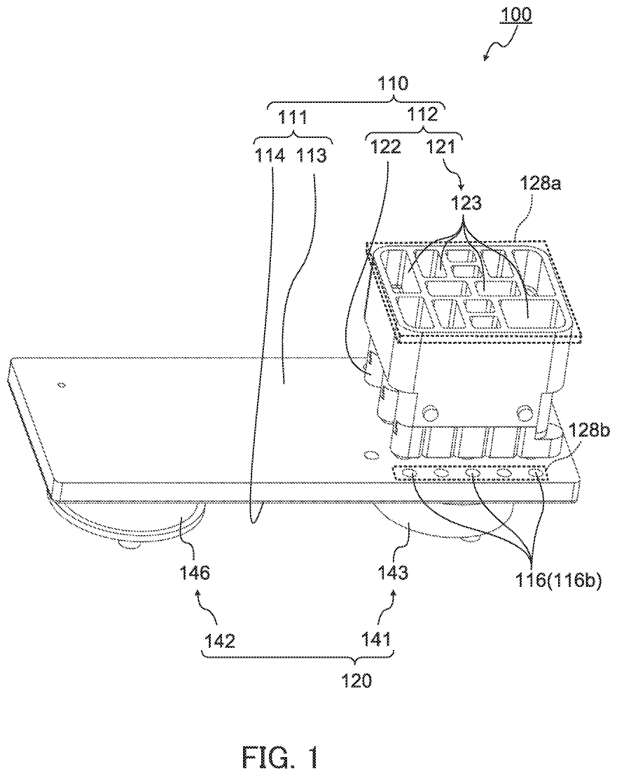

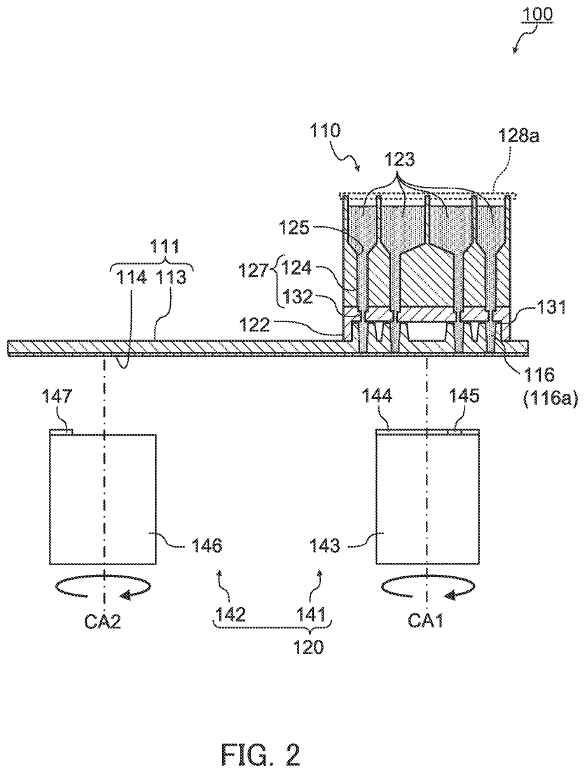

FIG. 1 is a perspective view illustrating a configuration of liquid handling system 100 according to the present embodiment. FIG. 2 is a schematic sectional view of liquid handling system 100. Note that in FIG. 2, the components are separated from each other for the sake of clear illustration of the configuration of liquid handling system 100. In addition, in FIGS. 1 and 2, sealing members (first sealing member 128a and second sealing member 128b) are illustrated with the dotted line.

As illustrated in FIGS. 1 and 2, liquid handling system 100 includes liquid handling device 110 including channel chip 111 and cartridge 112, and liquid containing control device 120 including first rotary member 141 and second rotary member 142. First rotary member 141 is rotated by a driving mechanism not illustrated in the drawing around first central axis CAE Second rotary member 142 is rotated by a driving mechanism not illustrated in the drawing around second central axis CA2. Liquid handling device 110 includes substrate 113 and film 114, and is installed such that film 114 makes contact with first rotary member 141 and second rotary member 142.

Liquid handling device 110 includes channel chip 111 and cartridge 112.

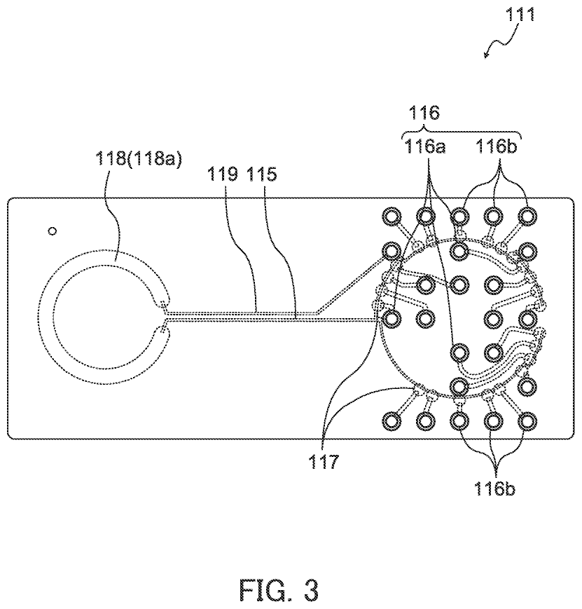

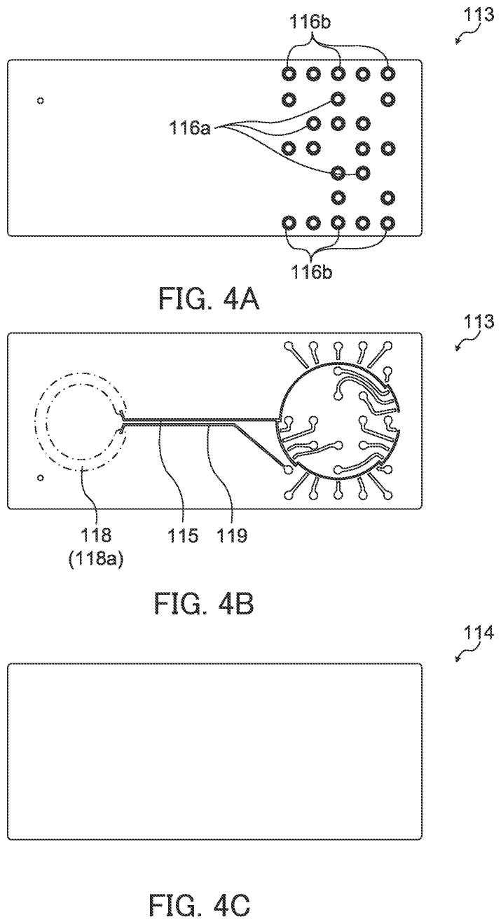

FIG. 3 is a plan view of channel chip 111 (plan view of substrate 113). FIG. 4A is a plan view of substrate 113, FIG. 4B is a bottom view of substrate 113, and FIG. 4C is a plan view of film 114. In FIG. 3, a groove (channel) formed in the surface of substrate 113 on film 114 side and the like are illustrated with the broken line.

As illustrated in FIGS. 1 and 2, channel chip 111 includes substrate 113 and film 114. As illustrated in FIGS. 3 and 4A to 4C, in substrate 113, a groove serving as a channel, a recess serving as a well, and a through hole serving as an inlet or outlet are formed. Film 114 is joined to one surface of substrate 113 so as to seal the openings of the groove, recess and through hole formed in substrate 113. A part of the region of film 114 functions as a diaphragm. The groove of substrate 113 sealed with film 114 serves as a channel for carrying liquid such as reagent, liquid samples, and washing solution.

The thickness of substrate 113 is not limited. For example, the thickness of substrate 113 is 1 mm to 10 mm. In addition, the material of substrate 113 is not limited.

For example, the material of substrate 113 may be appropriately selected from publicly known resins and glass. Examples of the material of substrate 113 include polyethylene terephthalate, polycarbonate, polymethylmethacrylate, polyvinyl chloride, polypropylene, polyether, polyethylene, polystyrene, cyclo-olefin resin, silicone resin and elastomer.

The thickness of film 114 is not limited as long as it can function as a diaphragm. For example, the thickness of film 114 is 30 μm to 300 μm. In addition, the material of film 114 is not limited as long as it can function as a diaphragm. For example, the material of film 114 may be appropriately selected from publicly known resins. Examples of the material of film 114 include polyethylene terephthalate, polycarbonate, polymethylmethacrylate, polyvinyl chloride, polypropylene, polyether, polyethylene, polystyrene, cyclo-olefin resin, silicone resin and elastomer. Film 114 is joined to substrate 113 by thermal welding, laser welding, adhesive agent, and the like, for example.

In the present embodiment, channel chip 111 includes first channel 115, a plurality of wells 116 each of which is connected to first channel 115, and a plurality of valves 117 each of which is disposed between well 116 and first channel 115. The number of well 116 and valve 117 is not limited, and is appropriately set in accordance with the use of channel chip 111.

Well 116 is a bottomed recess for introducing a sample such as blood, washing solution and the like, or discharging waste liquid. In the present embodiment, well 116 includes first well 116a to which first reservoir part 123 of cartridge 112 in which a first reagent that can be preserved in a non-frozen state is stored is connected, and second well (second reservoir part) 116b in which a second reagent that should be preserved in a frozen state is stored. In the present embodiment, each recess is composed of the through hole formed in substrate 113 and film 114 closing one opening of the through hole. The shapes and sizes of these recess are not limited, and may be appropriately set in accordance with the shape of connecting tube 127. The shape of these recess is a substantially columnar shape, for example. The width of these recess is approximately 2 mm, for example.

Connecting tube 127 of cartridge 112 is connected to first well 116a. On the other hand, connecting tube 127 is not connected to second well 116b. That is, in the present embodiment, it is preferable that the opening of second well 116b be open at the region other than the region where cartridge 112 is mounted. In this manner, also in the state where cartridge 112 is mounted, solution for dissolving the second reagent and the like can be injected to second well 116b, for example.

Second well 116b stores the second reagent that should be preserved in a frozen state, and is connected to first channel 115. The second reagent that should be preserved in a frozen state includes lyophilized reagent. That is, the second reagent is a reagent that is frozen when it is stored and transported, and is melted or dissolved when it is used. The second reagent is a reagent that is generally used in smaller quantities. Examples of the second reagent include antibodies, enzymes, aptamers, fluorescent reagents, peptides, DNA, and RNA.

It is preferable that the opening of second well 116b be sealed with second sealing member 128b during transportation, and that the sealing be released when it is used. The method of sealing the opening of second well 116b is not limited as long as the second reagent can be stored in second well 116b, and the opening of second well 116b may be sealed by publicly known methods.

First channel 115 is a channel through which liquid can move inside. A plurality of end portions of first channel 115 on one side is connected to first well 116a or second well 116b. The end portion of first channel 115 on the other side is connected to rotary membrane pump 118. First channel 115 is composed of the groove formed in substrate 113 and film 114 closing the opening of the groove. The cross-sectional area and cross-sectional shape of first channel 115 are not limited. In this specification, “cross-section of the channel” means the cross-section of the channel orthogonal to the liquid flow direction. The cross-sectional shape of the channel is a substantially rectangular shape with one side with a length (width and depth) of approximately several tens of micrometers, for example. The cross-sectional area of the channel may be or may not be constant in the liquid flow direction. In the present embodiment, the cross-sectional area of the channel is constant.

The plurality of valves 117 are membrane valves (diaphragm valves) disposed between first channel 115 and a plurality of first wells 116a or a plurality of second wells 116b, and configured to control the liquid flow therebetween. In the present embodiment, these valves are rotary membrane valves for which the opening and closing are controlled by the rotation of first rotary member 141. In the present embodiment, these valves are disposed on the circumference of a circle around first central axis CA1 at the center.

Rotary membrane pump 118 is a space with a substantially arc-shape (“C”-shape) in plan view formed between substrate 113 and film 114. One end of rotary membrane pump 118 is connected to first channel 115, and the other end of rotary membrane pump 118 is connected to second channel 119 opening to the outside. Second channel 119 is composed of the groove formed in substrate 113 and film 114 closing the opening of the groove. In the present embodiment, rotary membrane pump 118 is composed of the groove disposed in the bottom surface of substrate 113, and diaphragm 118a, which is a part of a flat and flexible film 114 facing the groove. Diaphragm 118a is disposed on the circumference of a circle around second central axis CA2 at the center. The cross-sectional shape of diaphragm 118a orthogonal to the above-mentioned circumference of a circle is not limited, but is a linear shape in the present embodiment. Note that rotary membrane pump 118 may be composed of the bottom surface of substrate 113, and diaphragm 118a facing the bottom surface while being separated from the bottom surface.

Diaphragm 118a of rotary membrane pump 118 makes contact with deflected substrate 113 when pressed by second protrusion 147 of second rotary member 142. For example, when second protrusion 147 slides and presses diaphragm 118a (counterclockwise, in FIG. 3) from the connecting part connected with first channel 115 toward the connecting part connected with second channel 119, the fluid in first channel 115 moves toward rotary membrane pump 118 and sets the inside of first channel 115 to negative pressure, while the fluid in rotary membrane pump 118 moves toward second channel 119 and sets the inside of second channel 119 to positive pressure. On the other hand, when second protrusion 147 slides and presses diaphragm 118a (clockwise, in FIG. 3) from the connecting part connected with second channel 119 toward the connecting part connected with first channel 115, the fluid in second channel 119 moves toward rotary membrane pump 118 and sets the inside of second channel 119 to negative pressure, while the fluid (such as air) in rotary membrane pump 118 moves toward first channel 115 and sets the inside of first channel 115 to positive pressure.

As illustrated in FIGS. 1 and 2, cartridge 112 is configured to be attachable and detachable to and from channel chip 111, and includes cartridge main body 121 and slide part 122. Note that in the embodiment, cartridge 112 includes first sealing member 128a, in addition to the above-mentioned configurations.

Cartridge main body 121 is configured to be attachable and detachable to and from slide part 122, and slidable. Cartridge main body 121 includes a plurality of first reservoir parts 123. Note that in the present embodiment, cartridge main body 121 further includes first connecting tube 124, which is a part of connecting tube 127.

The plurality of first reservoir parts 123 stores the first reagent. The volumes of the plurality of first reservoir parts 123 are not limited. The volumes of the plurality of first reservoir parts 123 may be the same or different from each other. The number of the plurality of first reservoir parts 123 is not limited. In the present embodiment, thirteen first reservoir parts 123 are provided.

Through hole 125 configured to be connected to the channel (first channel 115) of channel chip 111 opens at the bottom portion of first reservoir part 123.

First reservoir part 123 stores the first reagent that can be preserved in a non-frozen state. The first reagent can be stored in a frozen state or a non-frozen state. In the present embodiment, the first reagent is not frozen, but is liquid. In the present embodiment, first reservoir part 123 is sealed with first sealing member 128a and thus the first reagent does not spill out when it is stored or transported. Examples of the first reagent include washing solution, buffer solution, water, diluted solution, dye solution (excluding fluorescent dye), and liquid containing magnetic beads.

The ratio of the volume of first reservoir part 123 to the volume of second well (second reservoir part) 116b is preferably 30:1 to 70:1, more preferably 10:1 to 20:1. To be more specific, for example, the volume of second well (second reservoir part) 116b is approximately 10 μL, and the volume of first reservoir part 123 is approximately 100 to 200 μL. The above-described cartridge 112 (cartridge main body 121) needs to be large to some degree to store the first reagent such as washing solution that needs to have some quantity, and ensure the handleability. As a result, the size of first reservoir part 123 also increases to some degree. If first reservoir part 123 stores only small quantities of reagent (second reagent) that is used only in small quantities, the reagent (the second reagent) that is used only in small quantities may adhere to the inner wall of first reservoir part 123 and thus may not be used. Therefore, the reagent to be stored in first reservoir part 123 needs to have some quantities. In this case, the quantity of the reagent to be input should be greater than the required quantity, and further the volume of first connecting tube 124 is wasted. In view of this, by reducing the volume of second well (second reservoir part) 116b relative to the volume of first reservoir part 123, the dead volume in second well (second reservoir part) 116b can be reduced, and thus the waste of the second reagent can be reduced.

First connecting tube 124 is a part of connecting tube 127 on the upstream side. The upstream end of first connecting tube 124 is connected to first reservoir part 123, and the downstream end is connected to second connecting tube 132.

It is preferable that the channel between second well (second reservoir part) 116b and first channel 115 be shorter than the channel between first reservoir part 123 and first channel 115. In this manner, the waste of the second reagent stored in second well (second reservoir part) 116b can be further reduced.

Slide part 122 includes packing 131 and second connecting tube 132, which is the downstream side of connecting tube 127, and thus slide part 122 is configured to be slidable with respect to cartridge main body 121 (see FIG. 1). Packing 131 is disposed between well 116 and second connecting tube 132, and prevents leakage of the first reagent liquid from the part between connecting tube 127 and well 116.

Second connecting tube 132 is a part of connecting tube 127 on packing 131 side. First connecting tube 124 is connected to one end portion of second connecting tube 132, and packing 131 is disposed at the other end portion of it (see FIG. 2).

Connecting tube 127 connects between first reservoir part 123 and packing 131 not only in the state where the channel between first reservoir part 123 and packing 131 is communicated, but also in the state where the channel between first reservoir part 123 and packing 131 is blocked. The material of connecting tube 127 is not limited as long as the connection between first reservoir part 123 and packing 131 can be maintained.

Examples of the material of connecting tube 127 include silicone, urethane, polytetrafluoroethylene (PTFE), and Tygon (registered trademark), which is a polyvinyl chloride resin.

By sliding cartridge main body 121 with respect to slide part 122, the channel between first reservoir part 123 and packing 131 can be opened and closed.

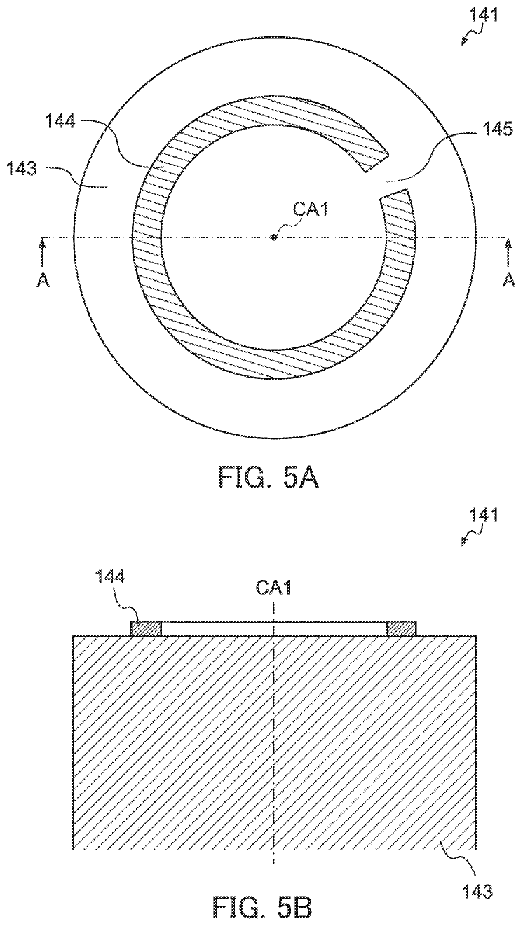

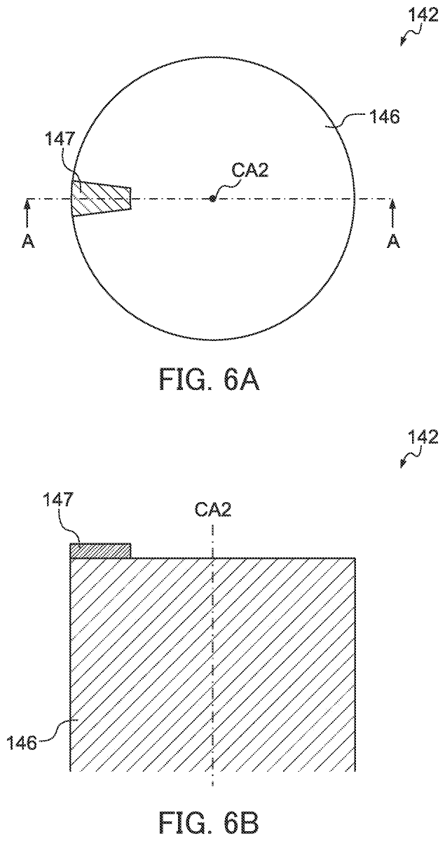

FIG. 5A is a plan view of first rotary member 141, and FIG. 5B is a sectional view taken along line A-A of FIG. 5A. FIG. 6A is a plan view of second rotary member 142, and FIG. 6B is a sectional view taken along line A-A of FIG. 6A.

Liquid control device 120 includes first rotary member 141 and second rotary member 142 (see FIGS. 1 and 2).

As illustrated in FIGS. 5A and 5B, first rotary member 141 includes first body 143 with a columnar shape, first protrusion 144 disposed at the top surface of first body 143, and first recess 145 disposed at the top surface of first body 143. First body 143 is rotated around first central axis CA1 at the center by the driving mechanism not illustrated in the drawing.

First protrusion 144 for closing valve 117 by pressing diaphragm 118a of valve 117, and first recess 145 for opening the diaphragm without pressing the diaphragm are disposed at the upper part of first body 143. First protrusion 144 and first recess 145 are disposed on the circumference of a circle around first central axis CA1 at the center. In the present embodiment, the shape of first protrusion 144 in plan view is an arc-shape (“C”-shape) corresponding to a part of the circle around first central axis CA1 at the center. The region where first protrusion 144 is not present on the circumference is first recess 145.

As illustrated in FIGS. 6A and 6B, second rotary member 142 includes second body 146 with a columnar shape, and second protrusion 147 disposed at the top surface of second body 146. Second body 146 can rotate around second central axis CA2 at the center. Second body 146 is rotated by the driving mechanism not illustrated in the drawing.

Second protrusion 147 for operating rotary membrane pump 118 by pressing diaphragm 118a while sliding diaphragm 118a is provided at the upper part of second body 146. Second protrusion 147 is disposed on the circumference of a circle around second central axis CA2 at the center. The shape of second protrusion 147 is not limited as long as rotary membrane pump 118 can be appropriately activated. In the present embodiment, the shape of second protrusion 147 in plan view is an arc-shape corresponding to a part of the circle around second central axis CA2.

In liquid handling system 100 according to the present embodiment, first protrusion 144 of first rotary member 141 controls the opening and closing of the plurality of valves 117 of channel chip 111. To achieve this configuration, the plurality of valves 117 of channel chip 111 and first protrusion 144 of first rotary member 141 are disposed on the circumference of a first circle around first central axis CA1 at the center.

Likewise, in liquid handling system 100 according to the present embodiment, second protrusion 147 of second rotary member 142 controls the operation of rotary membrane pump 118 of channel chip 111. To achieve this configuration, rotary membrane pump 118 of channel chip 111 and second protrusion 147 of second rotary member 142 are disposed on the circumference of a second circle around second central axis CA2 at the center.

In liquid handling device 110 having the above-mentioned configuration, cartridge 112 is mounted to channel chip 111 when it is used. In this case, the first reagent that can be preserved in a non-frozen state is stored in first reservoir part 123 of cartridge 112. Note that in the case where the first reagent in a frozen state is stored in first reservoir part 123, cartridge 112 may be mounted in channel chip 111 in advance.

### Operation of Liquid Handling System

Liquid handling system 100 according to the present invention is used in the state where liquid handling device 110 with cartridge 112 mounted to channel chip 111 is mounted in liquid control device 120.

Liquid handling device 110 opens valve 117 corresponding to well 116 to be moved, by rotating first rotary member 141 around first central axis CA1 at the center. Next, the liquid in well 116 is moved to first channel 115 by rotating second rotary member 142 around second central axis CA2 at the center.

Next, valve 117 corresponding to well 116 to which the liquid in first channel 115 is to be moved is opened by rotating first rotary member 141 around first central axis CA1 at the center. Next, the liquid in first channel 115 is moved to well 116 to which the liquid in first channel 115 is to be moved by rotating second rotary member 142 around second central axis CA2 at the center.

As described above, various reactions are caused by moving the liquid by repeating the movement of the liquid (the first reagent or the second reagent) from well 116 to first channel 115, and the movement of the liquid (the first reagent or the second reagent) from first channel 115 to well 116.

### Effect

In the above-described manner, with liquid handling device 110 according to the present embodiment, the second reagent that should be preserved in a frozen state is stored in the channel chip in advance, and thus the waste of the second reagent can be reduced.

### INDUSTRIAL APPLICABILITY

The liquid handling device and the liquid handling system according to the present embodiment are useful for various uses such as laboratory tests, food tests and environment tests, for example.

### REFERENCE SIGNS LIST

100 Liquid handling system
110 Liquid handling device
111 Channel chip
112 Cartridge
113 Substrate
114 Film
115 First channel
116 Well
116a First well
116b Second well
117 Valve
118 Rotary membrane pump
118a Diaphragm
119 Second channel
120 Liquid control device
121 Cartridge main body
122 Slide part
123 First reservoir part
124 First connecting tube
125 Through hole
127 Connecting tube
128a First sealing member
128b Second sealing member
131 Packing
132 Second connecting tube
141 First rotary member
142 Second rotary member
143 First body
144 First protrusion
145 First recess
146 Second body
147 Second protrusion
CA1 First central axis
CA2 Second central axis

What is claimed is:

1. A liquid handling device comprising:
a cartridge including a first reservoir part in which a first reagent that is preservable in a non-frozen state is stored; and
a channel chip including a second reservoir part in which a second reagent that should be preserved in a frozen state is stored, and a channel connected to the second reservoir part,
wherein the cartridge is attachable and detachable to and from the channel chip, and
wherein the first reservoir part is connected to the channel when the cartridge is mounted in the channel chip.

2. The liquid handling device according to claim 1, wherein a ratio of a volume of the first reservoir part to a volume of the second reservoir part is 30:1 to 70:1.

3. The liquid handling device according to claim 1, wherein an opening of the first reservoir part and an opening of the second reservoir part are sealed.

4. The liquid handling device according to claim 1, wherein the second reservoir part is open at a region other than a region where the cartridge is mounted in the channel chip.

5. A liquid handling system comprising:
the liquid handling device according to claim 1; and
a liquid control device configured to control liquid flowing through the liquid handling device.

6. The liquid handling device according to claim 2, wherein an opening of the first reservoir part and an opening of the second reservoir part are sealed.

7. The liquid handling device according to claim 2, wherein the second reservoir part is open at a region other than a region where the cartridge is mounted in the channel chip.

8. The liquid handling device according to claim 3, wherein the second reservoir part is open at a region other than a region where the cartridge is mounted in the channel chip.

9. The liquid handling device according to claim 6, wherein the second reservoir part is open at a region other than a region where the cartridge is mounted in the channel chip.

10. A liquid handling system comprising:
the liquid handling device according to claim 2; and
a liquid control device configured to control liquid flowing through the liquid handling device.

11. A liquid handling system comprising:
the liquid handling device according to claim 3; and
a liquid control device configured to control liquid flowing through the liquid handling device.

12. A liquid handling system comprising:
the liquid handling device according to claim 4; and
a liquid control device configured to control liquid flowing through the liquid handling device.

13. A liquid handling system comprising:
the liquid handling device according to claim 6; and
a liquid control device configured to control liquid flowing through the liquid handling device.

14. A liquid handling system comprising:
the liquid handling device according to claim 7; and
a liquid control device configured to control liquid flowing through the liquid handling device.

15. A liquid handling system comprising:
the liquid handling device according to claim 8; and
a liquid control device configured to control liquid flowing through the liquid handling device.

16. A liquid handling system comprising:
the liquid handling device according to claim 9; and
a liquid control device configured to control liquid flowing through the liquid handling device.
